(19) United States
(12) Patent Application Publication
(10) Pub. No.: US 2007/0089846 A1
(43) Pub. Date: Apr. 26, 2007

(54) Silver-impregnated lignocellulose (sil): process for making and using same

(76) Inventor: Ju Young Kim, Tallahassee, FL (US)

Correspondence Address: LANGDALE & VALLOTTON, LLP, 1007 N. PATTERSON STREET, VALDOSTA, GA, 31601, US

(21) Appl. No.: 10/572,290

(22) PCT Filed: Jan. 25, 2005
(86) PCT No.: PCT/US05/02292

§ 371 Date: Mar. 14, 2006

Related U.S. Application Data
(60) Provisional application No. 60/481,976, filed on Jan. 30, 2004.

(51) Int. Cl. B27K 3/34; B27K 3/02; D21H 21/36

(52) U.S. Cl. 162/161; 162/135; 162/184; 162/181.1; 427/439; 427/440; 252/380

(57) ABSTRACT

A process for making a silver-impregnated lignocellulose (SIL) is disclosed, comprising associating metal cations (Al or Fe) with soluble polymers, penetrating the cation-polymer complex into a lignocellulose matrix; and irreversibly associating the cation- polymer complex with the lignocellulose matrix by drying the lignocellulose matrix, such that leaching will not occur upon rehydration.

### CROSS-REFERENCES TO RELATED APPLICATIONS

None

### STATEMENT REGARDING FEDERALLY SPONSORED RESEARCH OR DEVELOPMENT

None

### REFERENCE TO “SEQUENCE LISTING”

None

### BACKGROUND OF THE INVENTION

At the turn of the 21^{st} Century, over 7 billion linear feet of lumber was treated with biocide to prevent decay. Of this, approximately 80% was pressure treated with chromated copper arsenic (CCA). Because these preservatives leach from treated wood into the environment where they may pose serious health threats to a variety of organisms, including humans, the use of CCA is currently being phased out. Available alternative treatments include alkaline copper quat and copper azole. These treatments likewise suffer from leaching problems. Although copper is much less toxic to animals than are chromium and arsenic, its toxicity in aquatic and wetland ecosystems is problematic from an environmental perspective. Further, these alternative treatments are less effective than the CCA treatment they purport to replace.

Silver is benign to humans; so much that the cited effect of high-level exposure is arygria, a permanent discoloration of the skin that is of only cosmetic importance. Yet, silver is a potent antimicrobial agent with a wide range of action. For these reasons, there is substantial interest in the use of silver as a wood preservative. Legislation has been introduced in the United States Congress to “conduct a study of the effectiveness of silver-based biocides as an alternative treatment to preserve wood”. This illustrates both the promise of a silver-based technology, and the fact that this promise is as of the current time unrealized. Like the other treatments discussed above, silver treatments suffer from leaching problems. While this is not of environmental or human health concern because of the low toxicity of silver in these contexts, it does impact negatively on the efficacy of silver treatments: silver that has leached out of the wood no longer protects the wood from decay.

The toxic effect of silver on a wide variety of microorganisms has also been used in conjunction with the physical properties of lignocellulosics in the medical field. Medical bandages impregnated with silver have the ability to disinfect and protect wounds from bacteria, fungi, protozoa, and viruses, etc. This has proven to be of special benefit to bum victims, in which cases it has been reported that skin renewal can be speeded by a factor of 5 by use of silver. Currently, bandage material is impregnated with silver by treatment with silver nitrate; however, as is the case for wood preservation applications, silver leaching is a problem.

For the foregoing reasons, there is a need for a means of permanently impregnating lignocellulose with silver. The permanent fixation of silver to lignocellulose would be of clear benefit in a number of applications. Examples include wood preservation, bandages with anti-microbial properties, disinfection of water by filtration through such a medium, and the like.

### BRIEF SUMMARY OF THE INVENTION

The present invention is directed to a Silver-Impregnated Lignocellulose (SIL) and its methods of synthesis and use. SIL differs from other silver treatment methods in that the silver does not leach out of the product. Lumber to be used for construction of various structures may be converted to SIL, thereby protecting it from microbial attack and decay. Threats to wildlife and to human health are substantially reduced compared to existing technologies. Silver (Ag) is relatively nontoxic to mammals. Medical bandages may also be made of SIL, where the improved leaching characteristics will be of great benefit.

At the heart of the present invention is the concept of irreversibly associating the active agent, Ag, with lignocellulose. Lignocellulose is a combination of lignin, cellulose and hemicellulose that strengthens plant cells. The term lignocellulose refers broadly to plant tissue, both woody tissue such as aspen and pine wood, and non-woody tissue such as cotton and kenaf; to the main chemical constituents of plant tissue, such as cellulose, hemicellulose, starch, sugars, and lignin; and to products and byproducts that contain the above referenced chemical constituents or their reaction products, such as cloth, paper, dextran, and rayon. SIL may be manufactured from lignocellulose materials using one of two methodologies.

### DETAILED DESCRIPTION OF THE PREFERRED EMBODIMENTS

First Method:

The first methodology utilizes the following observations: (1) metal cations, such as Fe, Al, Ca, Mg, Mn, Co, Ni, and Zn, may be associated with soluble polymers, (2) the cation-polymer complex penetrates into the lignocellulose matrix, and (3) the cation-polymer complex irreversibly associates with the lignocellulose matrix upon drying, such that it is not leached out of rehydration. These principles have been verified in laboratory experiments in which iron (Fe) and aluminum (Al) cations were respectively mixed with an aqueous solution of sodium carboxymethylcellulose (CMC) and used to treat lignocellulose. In subsequent leaching experiments, iron and aluminum were not liberated from the resulting iron and aluminum impregnated lignocellulose.

A variety of soluble polymers other than CMC may be used. These include natural polymers such as seaweed extracts (e.g., agar, algin, carrageenan, fucoidan, furcellaran, laminaran), plant exudates (e.g., gum arabic, gum ghatti, gum karaya, gum tragacanth), seed gums (e.g., guar gum, locust bean gum, quince seed, psyllium seed, flax seed, okra gums), plant extracts (e.g., arabinogalactan, pectin, chitin), biosynthetic gums (e.g., xanthan, scleroglucan, dextran), starch fractions and derivatives (e.g., starch amylose, starch amylopectin, starch dextrins, starch hydroxyethyl ethers), and cellulose derivatives (e.g., methylcellulose, hydroxyalkyl derivatives of cellulose, ethlhydroxethlcellulose, CMC). Synthetic polymers, such as polyvinyl alcohol (PVA), polyethylene oxide (PEO), and polyacrylimides (PA), may also be employed. This polymer-based methodology may be used in two manufacturing methods.

1. In one version of this first method, the four basic steps by which SIL may be manufactured are, (a) dissociating the Ag cation from its counterion by dissolving a chemical compound containing Ag in a hydrophilic solvent; (b) forming an Ag-polymer complex by adding a polymer to the solution of step (a) that is soluble in the solvent system employed and mixing; (c) absorbing the Ag-polymer complex into a lignocellulose matrix by adding a lignocellulose to the solution of step (b) and incubating; and, (d) removing the lignocellulose of step (c) from the solution of step (c) and subjecting it to a drying treatment.
a. Dissociating the Ag cation from its counterion by dissolving a chemical compound containing Ag in a hydrophilic solvent:
   Add a compound containing Ag in a hydrophilic solvent, such as acids (HCL, H₂SO₄, HNO₃), bases (NaOH, KOH, CaOH or NH₄OH), and organic solvents (methane, ethane, acetone, etc.). Some examples of compounds containing Ag are silver acetate, silver bromide, silver carbonate, silver chloride, silver fluoride, silver iodide, silver nitrate, silver oxide, silver perrhenate, silver phosphate, silver sulfate, silver triocyanate, etc. The concentration of Ag and corresponding volume employed is chosen by reference to considerations well-known to those skilled in the art of chemistry to ensure that a sufficient but not overabundant amount of Ag will be absorbed by the lignocellulose added in step (c).
b. Forming a Ag-polymer complex by adding a polymer to the solution of step (a) that is soluble in the solvent system employed and mixing:
   Add a polymer such as CMC to the solution of step (a). The type of CMC (degree of substitution, degree of polymerization) and its ratio to Ag are chosen by reference to optimization processes well-known to those skilled in the art of chemistry. Step (b) is performed concurrently with step (a); these steps are described separately for ease of discussion only.
c. Absorbing the Ag-polymer complex into a lignocellulose matrix by adding a lignocellulose to the solution of step (b) and incubating:
   For the case of medical bandages and similar materials, the lignocellulose may simply be dipped into the treating solution of step (b). Alternatively, lignocellulose sheets may be sprayed with the solution of step (b). A pressure or vacuum treatment may be employed to facilitate penetration into the lignocellulose matrix.
d. Removing the lignocellulose of step (c) from the solution of step (c) and subjecting it to a drying treatment:
   Depending upon the application, treated lignocellulose from step (c) may be dried under ambient conditions or by exposure to partial vacuum and/or elevated temperature.

2. As an alternative version of this first method, the stability of the Fe-polymer-lignocellulose composite may be exploited to physically affix Ag particles to the lignocellulose matrix. The four basic steps by which SIL may be manufactured are, (a) dissociating iron (Fe) or aluminum (Al) cations from their counterions by dissolving a chemical compound containing the cations in a hydrophilic solvent; (b) forming a cation-polymer complex by adding a polymer to the solution of step (a) that is soluble in the solvent system employed and mixing; (c) forming a cation-polymer-Ag complex by adding Ag particles to the solution of step (b); (d) absorbing the cation-polymer-Ag complex into a lignocellulose matrix by adding a lignocellulose to the solution of step (c) and incubating; and, (e) removing the lignocellulose of step (d) from the solution of step (d) and subjecting it to a drying treatment.
a. Dissociating Fe or Al cations from their counterions by dissolving a chemical compound containing the cations in a hydrophilic solvent:
   Add a compound containing Fe or Al in a hydrophilic solvent such as water or methanol. Some examples of chemical compounds containing Fe or Al are: Fel₂, FeCl₂, FeCl₃, FeBr₂, FeBr₃, FeF₂, FeF₃, FeSO₄, Fe₂ (S0₄)₃, Fe(NO₃)₃, FePO₄, A11₃, AICl₃, AlBr₃, AlF₃, AlSO₄, Al₂(SO₄)₃, Al(NO₃)₃, AlPO₄ and the like. The concentration of Fe or Al and corresponding volume employed is chosen by reference to considerations well-known to those skilled in the art of chemistry to ensure that a sufficient but not overabundant amount of complexes described in step (c) will be absorbed by the lignocellulose added in step (d).
b. Forming a cation-polymer complex by adding a polymer to the solution of step (a) that is soluble in the solvent system employed and mixing:
   Add a polymer such as CMC to the solution of step (a). The type of CMC (degree of substitution, degree of polymerization) and its ratio to the cations in the solution of step (a) are chosen by reference to optimization processes well-known to those skilled in the art of chemistry. Step (b) is performed concurrently with step (a); these steps are described separately for ease of discussion only.
c. Forming a cation-polymer-Ag complex by adding Ag particles to the solution of step (b):
   Add Ag particles such as ceramic silver oxide particles (10⁻³ to about 10⁻⁹ m) or Ag nanoparticles (around 10⁻⁹ m). Step (c) may be performed concurrently with steps (a) and (b).
d. Absorbing the cation-polymer-Ag complex into a lignocellulose matrix by adding a lignocellulose to the solution of step (c) and incubating:
   For the case of medical bandages and similar materials, the lignocellulose may simply be dipped into the treating solution of step (c). Alternatively, lignocellulose sheets may be sprayed with the solution of step (c). A pressure or vacuum treatment may be employed to facilitate penetration into the lignocellulose matrix.
e. Removing the lignocellulose of step (d) from the solution of step (d) and subjecting it to a drying treatment:
   Depending upon the application, treating lignocellulose from step (c) may be dried under ambient conditions or by exposure to partial vacuum and/or elevated temperature.
      Second Method:

A second manufacturing methodology may also be used to manufacture SIL. This methodology exploits the replacement of the hydroxyl hydrogens (H) of lignocellulose with cations.

3. In a version of this second method, the three basic steps by which SIL may be manufactured are, (a) dissociating Ag cations from their counterions by dissolving a chemical compound containing Ag in water and acidifying; (b) absorbing the Ag cations to a lignocellulose having hydroxyl groups (—OH) by adding the lignocellulose to the solution of step (a) and incubating; and, (c) exposing the treated lignocellulose from step (b) to an alkaline fixing solution or gas that catalyzes the replacement of hydrogens (H) of the hydroxyl groups of the lignocellulose with Ag cations.
a. Dissociating Ag cations from their counterions by dissolving a chemical compound containing Ag in water and acidifying:
   Add a compound containing Ag in water. Some examples of compounds containing Ag are silver acetate, silver bromide, silver carbonate, silver chloride, silver fluoride, silver iodide, silver nitrate, silver oxide, silver perrhenate, silver phosphate, silver sulfate, silver triocyanate, etc. Acidify the solution to the extent required to dissociate Ag and to maintain it in the dissociated form. The concentration of Ag and corresponding volume employed is chosen by reference to considerations well-known to those skilled in the art of chemistry to ensure that a sufficient but not overabundant amount of Ag will be absorbed by the lignocellulose added in step (b) to bring about an efficient replacement reaction in step (c). For example, silver chloride at 0.01-3.0 M (molar concentration) dissociated by addition of acids such as HCl, H₂SO₄, HNO₃, and so on at 0.1-1.0 N (normal concentration) may be employed.
b. Absorbing the Ag cations to a lignocellulose having hydroxyl groups (—OH) by adding the lignocellulose to the solution of step (a) and incubating:
   For the case of medical bandages and similar materials, the lignocellulose may simply be dipped into the treating solution of step (c). Alternatively, lignocellulose sheets may be sprayed with the solution of step (c). A pressure or vacuum treatment may be employed to facilitate penetration into the lignocellulose matrix.
c. Exposing the treated lignocellulose from step (b) to an alkaline fixing solution or gas that catalyzes the replacement of hydrogens (H) of the hydroxyl groups of the lignocellulose with Ag cations:
   Expose the treated lignocellulose from step (b) to a fixing solution or gas. An alkali solution such as NaOH, KOH, Ca(OH)₂ or NH₄OH, or an alkali gas such as NH₄OH gas is used for this purpose. For example, fixation may be achieved by incubation for 0.1 to 10.0 minutes in a solution or gas of NH₄OH at 1.0-8.0 M. A pressure or vacuum treatment may be employed to facilitate penetration into the lignocellulose matrix. Unreacted Ag is then removed by rinsing the lignocellulose with water.
      Third Method:

The third method utilizes the same observations as the first method for keeping the lignocellulose media's structural integrity, but instead focuses on a one step silver coating process. The process of silver coating in the third method is as follows:

Fe or Al treated or untreated media is immersed into a silver salt solution. Irreversible silver coating may then be accomplished through treating the silver soaked media with NH₄OH, NaOH, KOH, or Ca(OH)₂ liquid or gas for a prescribed amount of time, followed by immediate immersion in water to cease all reaction processes. For example, fixation may be achieved by incubation for 0.1 to 10.0 minutes in a solution or gas of NH₄OH at 0.01-15.0 M, or NH₃ gas/air mix at 1% to 99% for anywhere from a few seconds to several minutes.

All the items discussed above are detailed explanations of the invention through examples for illustration only. Therefore, the invention should not be restricted to the above mentioned methods or processes. Other modifications and variations of the invention may be explored without any serious departure from the spirit and scope of the invention. The above-described embodiments are, therefore, intended to be merely exemplary, and all such variations and modifications are intended to be included within the scope of the invention. For example, lignocellulose may be modified in a similar fashion by use of other elemental salts containing F, Cu, Al, Ni, or Zn. In particular, the insecticidal properties of Ag could be beneficially employed as described above to protect wood from attack by termites, beetles, carpenter ants and carpenter bees. In addition, the antibiotic characteristics of Ag could prove beneficial in air filtration, water disinfection, and various medical sanitation utilizations, such as specifically treated bandaging and/or female menstruation padding.

What is claimed is:

1. A process for making silver-impregnated lignocellulose, comprising the steps of: (a) dissociating a Ag cation from its counterion by dissolving a chemical compound containing Ag in a hydrophilic solvent; (b) forming a Ag-polymer complex by adding a polymer to the solution of step (a) that is soluble in the solvent system employed, (c) absorbing the Ag-polymer complex into a lignocellulose matrix by adding a lignocellulose to the solution of step (b); incubating said absorbed Ag-polymer complex; and (d) removing the lignocellulose of step (c) from the solution of step (c) and subjecting said removed lignocellulose to a drying treatment.

2. A process for making silver-impregnated lignocellulose, comprising the steps of: (a) dissociating iron (Fe) or aluminum (Al) cations from their counterions by dissolving a chemical compound containing the cations in a hydrophilic solvent; (b) forming a cation-polymer complex by adding a polymer to the solution of step (a) that is soluable in the solvent system employed; (c) forming a cation-polymer-Ag complex by adding Ag particles to the solution of step (b); (d) absorbing the cation-polymer-Ag complex into a lignocellulose matrix by adding a lignocellulose to the solution of step (c) incubating said absorbed cation polymer-Ag complex; and, (e) removing the lignocellulose of step (d) from the solution of step (d) and; subjecting said removed lignocellulose to a drying treatment.

3. A process for making silver-impregnated lignocellulose, comprising the steps of; (a) dissociating Ag cations from their counterions by dissolving a chemical compound containing Ag in water and acidifying; (b) absorbing the Ag cations to a lignocellulose having hydroxyl groups (—OH) by adding the lignocellulose to the solution of step (a); incubating said absorbed Ag cation lignocellulose; and, (c) exposing the treated lignocellulose from step (b) to an alkaline fixing compound that catalyzes the replacement of hydrogens (H) of the hydroxyl groups of the lignocellulose with Ag cations.

4. A silver coating process for lignocellulose comprising the steps of immersing the lignocellulose into a silver salt solution, treating the silver-immersed lignocellulose with a base chosen from the group comprising NH₄OH, NaOH, KOH, or Ca(OH)₂ for a predetermined time, and immersing said base immersed lignocellulose in water.
